(19) United States
(12) Patent Application Publication
(10) Pub. No.: US 2026/0250564 A1
(43) Pub. Date: Aug. 27, 2026

(54) MOISTURE-CROSSLINKABLE COMPOSITIONS AND SELF-ADHESIVE ARTICLES CONTAINING SAME

(71) Applicant: Bostik SA, Puteaux (FR)

(72) Inventors: Claire GARNIER, VENETTE (FR); Boris COLIN, VENETTE (FR)

(21) Appl. No.: 19/489,723

(22) PCT Filed: Jun. 3, 2024
(86) PCT No.: PCT/FR2024/050704

§ 371 Date: Dec. 3, 2025

(30) Foreign Application Priority Data
Jun. 6, 2023 (FR) FR2305668

(51) Int. Cl. C09J 165/00; C08G 77/08; C08K 5/134; C08K 5/5419

(52) U.S. Cl. CPC C09J 165/00; C08G 77/08; C08K 5/5419; C08K 5/134; C08K 2201/019

(57) ABSTRACT

The present invention relates to a moisture-crosslinkable adhesive composition comprising:
at least one silyl polymer (A);
a tackifying resin (B);
at least one compound (C) chosen from the group consisting of:
   compounds of formula (F1) and oligomeric/polymeric derivatives thereof:

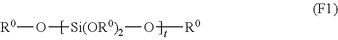

compounds of formula (F2):

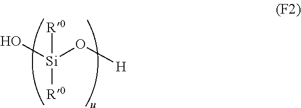

aminopolysiloxane compounds; and
mixtures thereof;
   said composition being characterized in that it has a glass transition temperature ranging from −25° C. to 20° C.

### FIELD OF THE INVENTION

The present invention relates to a novel silyl polymer-based moisture-crosslinkable adhesive composition.

The invention also relates to a self-adhesive article, in particular a self-adhesive support which comprises a support layer coated with a self-adhesive layer consisting of said composition in the crosslinked state. Finally, the invention relates to a process for the manufacture of said article.

### TECHNOLOGICAL BACKGROUND

Pressure-sensitive adhesives (PSAs) are substances which give an immediate tackiness at ambient temperature to the support layer on which they are coated. This immediate tackiness, often denoted by the term “tack”, makes possible the instantaneous adhesion of said self-adhesive support to all types of substrates, under the effect of a gentle and brief pressure. Due to its adhesiveness, usually evaluated by a peel test, said self-adhesive support is then firmly attached to said substrate by means of an adhesive seal.

PSAs are widely used in the manufacture of self-adhesive articles, such as, for example, of self-adhesive labels which are attached to articles for purposes of presentation of information (such as a barcode, name or price) and/or for decorative purposes, whether during permanent or temporary adhesive bonding operations.

PSAs are also employed in the manufacture of self-adhesive tapes of varied uses. Mention may be made, for example, besides the transparent adhesive tape widely used in daily life, of: the forming and the assembling of cardboard packagings; the protection of surfaces for painting operations, in the construction industry; the fixing and holding together of various elements, such as panels, bricks, protruding objects, in the construction of buildings or edifices; the fixing and holding together of metal, plastic or glass parts, flat or having specific profiles, such as electric cables, plastic films, window panes, metal sheets, inscriptions, logos, parts of seats, dashboards, plastic or textile walls, conduits or pipes for the circulation of fluids, in particular in the transportation industry; the adhesive bonding of fitted carpets by double-sided adhesive tapes in the construction field.

For the purpose of the manufacture of self-adhesive articles (for example of self-adhesive labels and/or tapes), PSAs are generally applied by continuous coating processes over the whole of the surface of a large-sized support layer (if appropriate printable), in the proportion of an amount (generally expressed in g/m²) denoted below by the term of “weight per unit area”. The support layer is, for example, paper or a film consisting of a polymeric material having one or more layers. The layer of self-adhesive composition which covers the support layer can be itself covered with a protective nonstick layer (often known as a release liner), for example consisting of a silicone film. The multilayer system obtained is generally packaged by winding in the form of large reels of up to 2 m in width and 1 m in diameter, which can be stored and transported.

These multilayer systems can subsequently be converted into self-adhesive labels which can be applied by the final user, by means of transformation processes which include the printing of the desired informative and/or decorative elements onto the printable face of the support layer, followed by cutting up to the desired shape and sizes. The protective nonstick layer can be easily removed without modifying the adhesive layer, which remains attached to the support layer. After separation from its nonstick protective layer, the label is applied to the article to be coated either manually or with the aid of labelling machines on automated packaging lines.

These multilayer systems may also be converted into self-adhesive tapes by cutting up and packaging as rolls of given widths and lengths with cutting up or pre-cutting of particular shapes that are useful for their final use, for instance for the assembly of parts of variable size and of variable shape, in the electronics industry, whether for industrial applications or for consumer purposes.

Patent applications WO 09/106699 and EP 2336208 already notably disclose heat-crosslinkable adhesive compositions, based on polyurethane (or polyether) bearing hydrolyzable alkoxysilane end groups, which, when coated onto a support and heated, lead, on conclusion of a chemical crosslinking reaction (hydrolysis and condensation) performed in the presence of moisture, to the production of a self-adhesive support which has the required adhesive power (or peel) and tack properties. This crosslinking reaction results in the formation of an adhesive seal which has a three-dimensional polymer network structure comprising siloxane bonds and which provides the attachment of the self-adhesive support to the substrate. Said self-adhesive support can thus be used for the manufacture of self-adhesive labels and/or tapes.

Self-adhesive labels or tapes can be used in applications involving high temperatures, for instance for protecting, masking, labeling or decorating parts in car engines or exhaust pipes, for the protection of electronic or electrical components in manufacturing processes, for cable wrapping in cars, or for the assembly of products in the transport industry. In this type of application, self-adhesive labels/tapes resistant to high temperatures are required. However, it is often difficult to achieve good heat resistance while maintaining good adhesive properties.

There is thus a need for novel adhesive compositions which have, after crosslinking, a compromise between good adhesive properties (for example 180° peeling), and good resistance to aging, notably under constraining temperature and humidity conditions.

There is notably a need for novel adhesive compositions which have, after crosslinking, good resistance to high temperatures (for example greater than or equal to 200° C.).

### DESCRIPTION OF THE INVENTION

### Composition

The present invention relates to a moisture-crosslinkable adhesive composition comprising:
at least one silyl polymer (A);
a tackifying resin (B);
at least one compound (C) chosen from the group consisting of:
   compounds of formula (F1) and oligomeric/polymeric derivatives thereof:

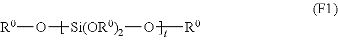

in which:
R⁰ is independently chosen from alkyls and aryls,
t represents an integer ranging from 1 to 20, preferentially from 1 to 7,
compounds of formula (F2):

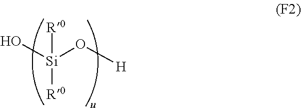

in which:
R′⁰ is independently chosen from alkyl groups comprising from 1 to 10 carbon atoms,
u is an integer ranging from 3 to 5000,
aminopolysiloxane compounds, and
mixtures thereof;
said composition being characterized in that it has a glass transition temperature ranging from −25° C. to 20° C.

The glass transition temperature (Tg) may be obtained by dynamic mechanical analysis (DMA). A preferred method is notably that performed in the experimental section.

Preferably, the adhesive composition is such that it has a glass transition temperature ranging from −25° C. to 20° C., preferentially from −20° C. to 15° C.

### Silyl Polymer (A)

The silyl polymer (A) preferably comprises at least one hydrolyzable alkoxysilane group, and preferably at least two hydrolyzable alkoxysilane groups.

The silyl polymer (A) is preferably a polymer comprising at least one, preferentially at least two, hydrolyzable groups of formula (I), in particular end groups:

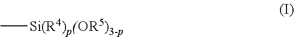

in which:
R⁴ represents a linear or branched alkyl group comprising from 1 to 4 carbon atoms, with the possibility that when there are several radicals R⁴, these radicals are identical or different;
R⁵ represents a linear or branched alkyl group comprising from 1 to 4 carbon atoms, with the possibility that when there are several radicals R⁵, these radicals are identical or different, with the possibility that two groups OR⁵ may be engaged in the same ring; and
p is an integer equal to 0, 1 or 2, preferably equal to 0 or 1.

According to the invention, the silyl polymer may bear a polyether main chain, a polyester main chain, a polyester-polyether-polyester main chain, a polyether-polyester-polyether main chain, a polyolefin main chain, a polycaprolactone main chain, a polyacrylate main chain, a polycarbonate main chain, a polyether-polycarbonate main chain, a polyester-polycarbonate main chain, a polyacetal main chain, a polyester-polyamide main chain, a polythioether main chain, a polyurethane main chain, a polyester-polyurethane main chain, a polyether-polyurethane main chain, a polyether-polyester-polyurethane main chain, a polyolefin-polyurethane main chain, a polyether-polyolefin-polyurethane main chain.

The silyl polymer may have a number-average molecular mass ranging from 500 to 50 000 g/mol, preferably ranging from 700 to 40 000 g/mol.

The number-average molecular mass of the silyl polymers (A) may be measured by methods that are well known to those skilled in the art, for example by size exclusion chromatography using polystyrene standards.

According to one embodiment of the invention, the silyl polymer (A) corresponds to one of the formulae (II), (III) or (IV) below:

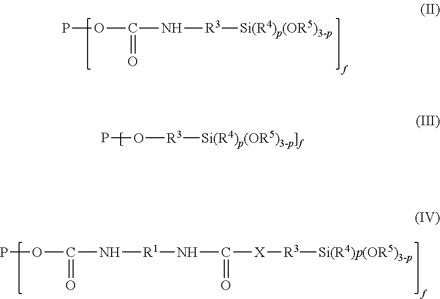

in which:
   R⁴, R⁵ and p have the same meaning as in formula (I) described above,
   P represents a saturated or unsaturated, linear or branched polymer radical optionally comprising one or more heteroatoms, such as oxygen, nitrogen, sulfur or silicon, and preferably having a number-average molar mass ranging from 100 g/mol to 50 000 g/mol, more particularly from 500 g/mol to 40 000 g/mol,
   R¹ represents a divalent hydrocarbon-based radical comprising from 5 to 15 carbon atoms, which may be aromatic or aliphatic,
   R³ represents a linear or branched divalent alkylene radical comprising from 1 to 6 carbon atoms, preferably from 1 to 3 carbon atoms,
   X represents a divalent radical chosen from —NH—, —NR⁷— or —S—,
   R⁷ represents a linear or branched alkyl radical comprising from 1 to 20 carbon atoms and which may also comprise one or more heteroatoms, and
   f is an integer ranging from 1 to 6, preferably ranging from 2 to 5, preferably from 2 to 4, more preferably from 2 to 3.

Preferably, in formulae (II), (III) and/or (IV) above, P represents a polymer radical chosen, in a nonlimiting manner, from polyethers, polycarbonates, polyesters, polyolefins, polyacrylates, polyether polyurethanes, polyester polyurethanes, polyolefin polyurethanes, polyacrylate polyurethanes, polycarbonate polyurethanes, and block polyether/polyester polyurethanes.

For example, EP 2 468 783 describes silyl polymers of formula (II) in which P represents a polymer radical containing polyurethane/polyester/polyether blocks.

According to one embodiment, the silyl polymers (A) are chosen from silyl polyurethanes, silyl polyethers, and mixtures thereof.

Preferably, the silyl polymer (A) corresponds to one of the formulae (II′), (III′) or (IV′):

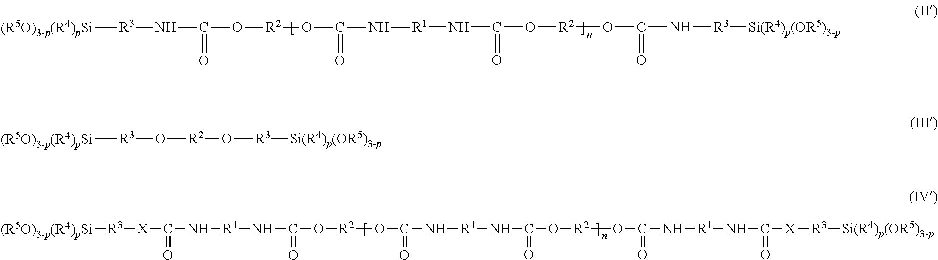

in which:
   R¹, R³, R⁴, R⁵, X, R⁷ and p have the same meaning as in formulae (II), (III) and (IV) described above,
   R² represents a saturated or unsaturated, linear or branched divalent hydrocarbon-based radical optionally comprising one or more heteroatoms, such as oxygen, nitrogen, sulfur or silicon, and preferably having a number-average molar mass ranging from 100 g/mol to 48 600 g/mol, more particularly from 300 g/mol to 38 600 g/mol, and
   n is an integer greater than or equal to 0.

In the silyl polymers (A) of formulae (II′), (III′) or (IV′) defined above, when the radical R² comprises one or more heteroatoms, said heteroatom(s) are not present at the end of the chain. In other words, the free valencies of the divalent radical R² bonded to the oxygen atoms neighboring the silyl polymer each originate from a carbon atom. Thus, the main chain of the radical R² is terminated with a carbon atom at each of the two ends, said carbon atom then having a free valency.

According to one embodiment, the silyl polymers (A) are obtained from polyols chosen from polyether polyols, polyester polyols, polycarbonate polyols, polyacrylate polyols, polysiloxane polyols and polyolefin polyols, and mixtures thereof, and more preferably from diols chosen from polyether diols, polyester diols, polycarbonate diols, polyacrylate diols, polysiloxane diols, polyolefin diols, and mixtures thereof. In the case of the polymers of formulae (II′), (III′) and (IV′) described above, such diols can be represented by the formula HO—R²—OH where R² has the same meaning as in the formulae (II′), (III′) and (IV′).

For example, among the radicals of R² type which may be present in formulae (II′), (III′) and (IV′), mention may be made of the following divalent radicals, the formulae of which below show the two free valencies:
derivative of a polypropylene glycol:

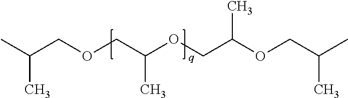

derivative of a polyester diol:

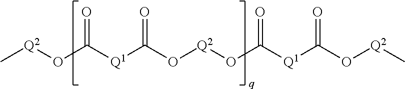

derivative of a polybutadiene diol:

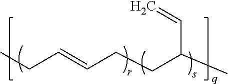

derivative of a polyacrylate diol:

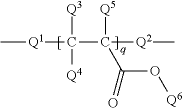

derivative of a polysiloxane diol:

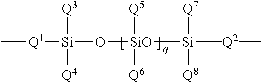

In the above formulae, the meaning of the radicals and indices is as follows:
q represents an integer such that the number-average molecular mass of the radical R² ranges from 100 g/mol to 48 600 g/mol, preferably from 300 g/mol to 18 600 g/mol, more preferably from 500 g/mol to 12 600 g/mol,
r and s represent zero or a non-zero integer such that the number-average molecular mass of the radical R² ranges from 100 g/mol to 48 600 g/mol, preferably from 300 g/mol to 18 600 g/mol, more preferably from 500 g/mol to 12 600 g/mol, it being understood that the sum r+s is other than zero,
Q¹ represents a linear or branched, saturated or unsaturated aromatic or aliphatic divalent alkylene radical preferably containing from 1 to 18 carbon atoms, more preferably from 1 to 8 carbon atoms,
Q² represents a linear or branched divalent alkylene radical preferably containing from 2 to 36 carbon atoms, more preferably from 1 to 8 carbon atoms,
Q³, Q⁴, Q⁵, Q⁶, Q⁷ and Q$ represent, independently of each other, a hydrogen atom or an alkyl, alkenyl or aromatic radical preferably containing from 1 to 12 carbon atoms, preferably from 2 to 12 carbon atoms, more preferably from 2 to 8 carbon atoms.

Preferably, the silyl polymer (A) is such that the radical R² which appears in formulae (II′), (III′) and (IV′) represents a polyether radical, preferably a poly(oxyalkylene) radical, and even more preferably a radical derived from a polypropylene glycol corresponding to the formula indicated above.

According to one embodiment, R¹ is chosen from one of the following divalent radicals, the formulae of which below show the two free valencies:
a) the divalent radical derived from isophorone diisocyanate (IPDI):

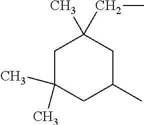

b) the divalent radical derived from dicyclohexylmethane diisocyanate (H12MDI)

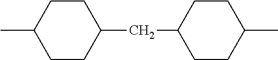

c) the divalent radical derived from toluene diisocyanate (TDI)

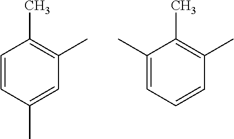

d) the divalent radicals derived from the 4,4′- and 2,4′-isomers of diphenylmethane diisocyanate (MDI):

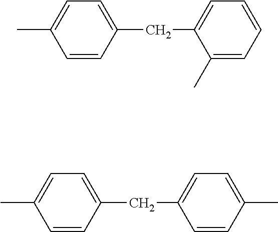

e) the divalent radical derived from hexamethylene diisocyanate (HDI)-(CH₂)₆-f) the divalent radical derived from m-xylylene diisocyanate (m-XDI):

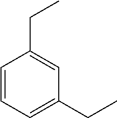

The polymers (A) of formula (II) or (II′) can be obtained according to a process described in EP 2 336 208 and WO 2009/106699. A person skilled in the art will know how to adapt the manufacturing process described in these two documents in the case of the use of different types of polyols. Among the polymers corresponding to formula (II), mention may be made of:
Geniosil® STP-E10 (available from Wacker): polyether comprising two groups (I) of dimethoxy type (n equal to 0, p equal to 1 and R⁴ and R⁵ represent a methyl group) having a number-average molar mass of 16 928 g/mol where R³ represents a methyl group;
Geniosil® STP-E30 (available from Wacker): polypropylene glycol with two alpha silane functions of methyl dimethoxy type, with a number-average molar mass of 24 000 g/mol;
Spur+® 1050MM (available from Momentive): polyurethane comprising two groups (I) of trimethoxy type (n other than 0, p equal to 0 and R⁵ represents a methyl group) having a number-average molar mass of 16 393 g/mol where R³ represents an n-propyl group;
Spur+® Y-19116 (available from Momentive): polyurethane comprising two groups (I) of trimethoxy type (n other than 0 and R⁵ represents a methyl group) having a number-average molar mass ranging from 15 000 to 17 000 g/mol where R³ represents an n-propyl group;
Desmoseal® S XP 2636 (available from Bayer): polyurethane comprising two groups (I) of trimethoxy type (n other than 0, p equal to 0 and R⁵ represents a methyl group) having a number-average molar mass of 15 038 g/mol where R³ represents an n-propylene group.

The polymers (A) of formula (III) or (III′) may be obtained by hydrosilylation of polyether diallyl ether according to a process described, for example, in EP 1 829 928.

Among the polymers corresponding to formula (III), mention may be made of:
the polymer MS SAX® 530 (available from Kaneka) corresponding to a polyether comprising two groups (1) of trimethoxy type (p equal to 1 and R⁴ and R⁵ represent a methyl group) having a weight-average molar mass ranging from 14 000 to 16 000 g/mol;
the polymer MS SAX® 260 (available from Kaneka) corresponding to a polyether comprising two groups (1) of dimethoxy type (p equal to 1 and R⁴ and R⁵ represent a methyl group) having a weight-average molar mass of 16 000 to 18 000 g/mol where R³ represents an ethyl group;
the polymer MS S303H (available from Kaneka) corresponding to a polyether comprising three groups (1) of dimethoxy type (p is equal to 1 and R⁴ represents a methyl group) having a weight-average molecular mass of about 22 000 daltons.

The silyl polymers (A) of formula (IV) or (IV′) may be obtained, for example, by reaction of polyol(s) with one or more diisocyanates followed by a reaction with aminosilanes or mercaptosilanes. A process for the preparation of polymers of formula (IV) or (IV′) is described in the document EP 2 583 988. A person skilled in the art will know how to adapt the manufacturing process described in said document in the case of using different types of polyols.

According to a preferred embodiment of the invention, the adhesive composition comprises at least one silyl polymer (A) of formula (II) and/or (II′) or at least one silyl polymer of formula (III) and/or (III′).

According to a most particularly preferred embodiment of the invention, the silyl polymer is a silyl polymer of formula (II′) in which R² is a divalent radical derived from a polyether, preferably from a poly(oxyalkylene) diol and even more particularly from a polypropylene glycol.

Preferably, the adhesive composition according to the invention comprises from 5% to 80% by weight of silyl polymer(s) (A), preferentially from 15% to 70% by weight and even more preferentially from 20% to 60% by weight, relative to the total weight of said composition.

### Tackifying Resin (B)

The adhesive composition according to the invention also comprises at least one tackifying resin (B).

Said resin may be any resin that is compatible with the silyl polymer(s) (A).

The term “compatible tackifying resin” denotes a tackifying resin which, when mixed in 50%/50% proportions with the silyl polymer(s) (A), gives a substantially homogeneous mixture.

The softening temperature (or point) is determined in accordance with the standardized test ASTM E28, the principle of which is as follows: a brass ring with a diameter of approximately 2 cm is filled with the test resin in the molten state. After cooling to ambient temperature, the ring and the solid resin are placed horizontally in a thermostatically controlled bath of glycerol or the like, the temperature of which can vary by 5° C. per minute. A steel ball with a diameter of about 9.5 mm is centered on the disk of solid resin. The softening temperature is—during the phase of rise in temperature of the bath at a rate of 5° C. per minute—the temperature at which the disk of resin yields by a height of 25.4 mm under the weight of the ball.

The tackifying resin (B) preferably has a softening point ranging from 60° C. to 115° C., more preferentially from 80° C. to 110° C.

The resins (B) are advantageously chosen from:
(i) terpene resins;
(ii) resins obtained by a process comprising the polymerization of α-methylstyrene, said process also possibly comprising a reaction with phenols;
(iii) rosins of natural origin or modified rosins (for instance the rosin extracted from pine gum, wood rosin extracted from tree roots and derivatives thereof which are hydrogenated, dimerized, polymerized or esterified with monoalcohols or polyols, such as glycerol or pentaerythritol);
(iv) aliphatic hydrocarbon-based resins which are optionally partially or totally hydrogenated,
(v) cycloaliphatic hydrocarbon-based resins which are optionally partially or totally hydrogenated,
(vi) aromatic-modified aliphatic or cycloaliphatic hydrocarbon-based resins, which are optionally partially or totally hydrogenated,
(vii) acrylic resins with a viscosity at 100° C. of less than 100 Pa·s, and
(viii) mixtures of these resins.

The terpene resins notably cover the resins synthesized by (co)polymerization of one or more terpene monomers, for instance α-pinene, β-pinene, D-limonene; the resins synthesized by copolymerization of one or more terpene monomers with one or more non-terpene monomers, for example chosen from styrene, methylstyrene, isoprene, etc., terpene-phenolic resins; and partially or totally hydrogenated derivatives thereof.

Resins synthesized by (co)polymerization of one or more terpene monomers are known under the name polyterpenes.

Terpene-phenolic resins (also called terpene phenols) are typically obtained by polymerization of terpene hydrocarbons and phenols, in the presence of a Friedel-Crafts catalyst.

Among the terpene resins, terpene-phenolic resins are preferred.

Among the terpene resins, mention may notably be made of Dercolyte® M105 available from the company Derives Resiniques et Terpeniques or DRT (which is a polyterpene resin with a softening point of 105° C.), Dertophene® T105 sold by DRT (which is a terpene-phenolic resin with a softening point of 105° C.), Dertophene® H150 available from the same company, with a molar mass Mn equal to about 630 D, Sylvalite 1105 sold by Kraton (which is a terpene-phenolic resin with a softening point of 105° C.), Picco® AR-85 available from the company Eastman (with a softening point of 85° C.), Picco® AR-100 also available from the company Eastman (with a softening point of 100° C.).

Among the resins of type (ii) are notably Cleartack® W100, available from the company Cray Valley, which is obtained by polymerization of α-methylstyrene without the action of phenols, with a number-average molar mass of 900 Da; Sylvarez® 510, which is also available from the company Arizona Chemical, with a molar mass Mn of about 1740 Da, the process for the production of which also comprises the addition of phenols.

Among the resins of type (iii), mention may be made, for example, of Sylvalite® RE 100, which is an ester of rosin and pentaerythritol, available from the company Arizona Chemical, with a molar mass Mn of about 1700 Da.

The optionally partially or totally hydrogenated aliphatic hydrocarbon-based resins are well known to those skilled in the art. These are resins resulting from the polymerization of mixtures of unsaturated aliphatic hydrocarbons containing, for example, 5 carbon atoms (which may, for example, be obtained from petroleum cuts or the like), followed by an optional (total or partial) hydrogenation step.

The partially or totally hydrogenated cycloaliphatic hydrocarbon-based resins are well known to those skilled in the art. These are resins resulting from the polymerization of mixtures of unsaturated cycloaliphatic hydrocarbons containing, for example, 10 carbon atoms (which may, for example, be obtained from petroleum cuts or the like), followed by an optional (total or partial) hydrogenation step. They may notably be obtained from dicyclopentadiene and derivatives thereof (methyldicyclopentadiene, dimethyldicyclopentadiene, etc.). Among the cycloaliphatic hydrocarbon-based resins, DCPD (dicyclopentadiene) resins are particularly preferred.

The aromatic-modified aliphatic or cycloaliphatic hydrocarbon-based resins can be obtained from the copolymerization of aliphatic (for example C5) or cycloaliphatic olefins and from aromatic (for example C9) olefins, followed by an optional (total or partial) hydrogenation step, the content of aliphatic or cycloaliphatic olefins being predominant relative to the aromatic olefins.

Mention may be made, for example, of Eastotac® H100W (C5 hydrogenated resin) from the company Eastman, with a softening point of 100° C., the resin Escorez® 5400 from the company Exxon Chemicals (hydrogenated DCPD resin) with a softening point of 100° C., and Sukorez® SU 100 (hydrogenated DCPD resin) from Kolon, with a softening point of 105° C.

Preferably, the tackifying resin (B) is chosen from terpene resins, and even more preferentially from terpene-phenolic resins.

Preferably, the adhesive composition according to the invention comprises from 15% to 90% by weight of tackifying resin(s) (B), preferentially from 30% to 80% by weight and even more preferentially from 40% to 70% by weight, relative to the total weight of said composition.

### Compound (C)

Compound (C) is chosen from the group constituted by:
compounds of formula (F1) and oligomeric/polymeric derivatives thereof:

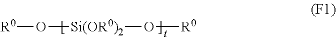

in which:
R⁰ is independently chosen from alkyls and aryls,
t represents an integer ranging from 1 to 20, preferentially from 1 to 7,
compounds of formula (F2):

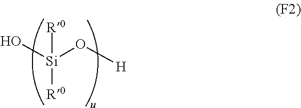

in which:
   R′⁰ is independently chosen from alkyl groups comprising from 1 to 10 carbon atoms,
   u is an integer ranging from 3 to 5000,
aminopolysiloxane compounds, and
mixtures thereof.

### Compounds of Formula (F1) and Derivatives Thereof

In the abovementioned formula (F1), the groups R⁰ may be identical or different. This is also true for different repetitive units t, R⁰ may be identical or different.

The oligomeric/polymer derivatives of the compounds of formula (F1) may typically be obtained by partial hydrolysis and partial condensation of the compounds of formula (F1). This can be done by adding water and catalytic amounts of acid (for instance HCl). Some hydrolyzed —OR groups then release water and the intermediate silanols react by condensation to form Si—O—Si bonds and water.

Preferably, the compounds of formula (F1), and the oligomeric/polymer derivatives thereof are those in which:
R⁰ is chosen from ethyl, n-propyl, butyl or isopropyl; and/or
t is an integer ranging from 1 to 20.

Even more preferably, the compounds of formula (F1), and the oligomeric/polymer derivatives thereof, are those in which:
R⁰ is an ethyl; and/or
t is an integer ranging from 2 to 7.

The compounds (C) may be chosen from tetraethoxyorthosilicates, tetrapropoxyorthosilicates, tetraisopropoxyorthosilicates, tetrabutoxyorthosilicates and oligomeric/polymer derivatives thereof, and mixtures thereof.

Preferably, the compounds (C) are chosen from tetraethoxyorthosilicates, the oligomeric/polymer derivatives thereof, and mixtures thereof.

Such compounds are sold, for example, by Wacker under the name Wacker® Silicate TES 40 WN (partially oligomerized tetraethoxyorthosilicate), or alternatively sold by Evonik under the name Dynasylan® 40 (partially oligomerized tetraethoxyorthosilicate), or alternatively TES28 sold by Wacker (CAS 78-10-4, R=ethyl, and n=1).

### Compounds of Formula (F2)

In the abovementioned formula (F2), the groups R′⁰ may be identical or different. This is also true for different repeating units u, R′⁰ may be identical or different.

The compound of formula (F2) may have a number-average molecular mass ranging from 100 to 300 000 g/mol, preferably from 200 to 100 000 g/mol and even more preferentially from 500 to 50 000 g/mol.

The number-average molecular mass of the compounds of formula (F2) can be measured via methods that are well known to those skilled in the art, for example by size exclusion chromatography, for example using polystyrene standards.

The compounds of formula (F2) are preferably those in which:
R′⁰ is independently chosen from alkyl groups comprising from 1 to 2 carbon atoms,
u is an integer ranging from 5 to 3000.

The compounds of formula (F2) are notably sold by the company CHT under the name Hansa SFA 92135 or Hansa SFA 92013.

### Aminopolysiloxanes

Aminopolysiloxanes are polysiloxanes functionalized with at least one amino group.

The term “amino group” includes a primary amine, secondary amine or tertiary amine functional group.

The aminopolysiloxanes preferably have the formula (F3) below:

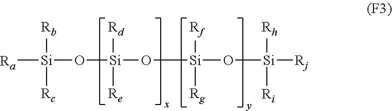

in which:
   R^{a}, R^{b}, R^{c}, R^{d}, R^{e}, R^{f}, R^{g}, R^{h}, Rⁱ or R^{j} represent, independently of each other, a linear or branched alkyl group, an aryl group, a cycloaliphatic group, an alkoxy group, a group —NR^{p}R^{q} with R^{p} and R^{q} independently representing, independently of each other, a hydrogen atom, an optionally substituted alkyl radical, an aryl radical;
   x represents an integer ranging from 1 to 100;
   y represents an integer ranging from 1 to 1000;
      characterized in that at least one of the groups R^{a}, R^{b}, R^{c}, R^{d}, R^{e}, R^{f}, R^{g}, R^{h}, Rⁱ or R^{j} represents a group —NR^{p}R^{q} with R^{p} and R^{q} representing, independently of each other, a hydrogen atom, an optionally substituted alkyl radical, an aryl radical.

The aminopolysiloxanes of formula (F3) are preferably those in which:
R^{a}, R^{b}, R^{c}, R^{d}, R^{e}, R^{f}, R^{g}, R^{h}, Rⁱ or R^{j} represent, independently of each other, a linear or branched alkyl group containing from 1 to 6 carbon atoms, preferably from one to two carbon atoms, an alkoxy group, a group —NR^{p}R^{q} with R^{p} and R^{q} independently representing a hydrogen atom, an optionally substituted alkyl radical, an aryl radical;
x represents an integer ranging from 1 to 100;
y represents an integer ranging from 1 to 1000.

Among the aminopolysiloxanes, mention may be made, for example, of (2-aminoethyl)methylpolysiloxane, (3-aminopropyl)methylpolysiloxane, (2-aminoethyl-3-aminopropyl)methylpolysiloxane, (3-2-aminoethylamino)propyl)methylsiloxane, (6-aminohexyl)methylpolysiloxane, and mixtures thereof.

Among the compounds of formula (F3), mention may be made, for example, of Hansa SFA 8030 or Hansa SFA 8018 sold by the company CHT.

Preferably, the compound (C) is chosen from the compounds of formula (F1) mentioned above and the oligomeric/polymer derivatives thereof.

Preferably, the compounds (C) are chosen from tetraethoxyorthosilicates, the oligomeric/polymer derivatives thereof, and mixtures thereof.

Preferably, the adhesive composition according to the invention comprises from 1% to 50% by weight of compounds (C), preferentially from 4% to 40% by weight and even more preferentially from 5% to 20% by weight, relative to the total weight of said composition.

### Crosslinking Catalyst (D)

Preferably, the adhesive composition according to the invention also comprises at least one crosslinking catalyst (D).

Said catalyst may be any catalyst known to a person skilled in the art for the condensation of silanol.

The crosslinking catalyst (D) may be chosen from the group consisting of:
(D1) organometallic compounds,
(D2) amines, and
(D3) acids and derivatives thereof,
and also mixtures thereof.

It may also be a mixture of catalysts belonging to the same group (D1), (D2) or (D3) (for example a mixture of several amines), or a mixture of catalysts belonging to at least two different groups chosen from the groups (D1), (D2) and (D3) (for example a mixture of an amine and of an organometallic compound).

In the context of the invention, the term “organometallic compounds” means compounds comprising an organic radical and at least one metal. In the context of the invention, the term “organic radical” means a radical comprising at least one carbon atom.

### (D1) Organometallic Compounds:

The organometallic compounds may comprise organometallic compounds (compounds comprising at least one metal-carbon covalent bond), metal alkoxides, metal carboxylates, and metallic coordination complexes with one or more organic ligands.

Examples of organic ligands that may be mentioned include acetylacetonate and oximes.

The metal atom of the organometallic compounds may be any metal atom known to those skilled in the art, and may be chosen in particular from tin, aluminum, zinc, cobalt, iron, nickel, bismuth, titanium, or zirconium. The organometallic compounds may moreover comprise several metal atoms.

### Compounds Comprising at Least One Metal-Carbon Covalent Bond:

The compounds comprising at least one metal-carbon covalent bond (organometallic compounds) may be carboxylates of organometallic compounds chosen from the group consisting of dibutyltin dilaurate (DBTL), dibutyltin diacetate, dibutyltin diethylhexanoate, dioctyltin dineodecanoate (available, for example, under the name TIB KAT® 223 from the company TIB Chemicals), dibutyltin dioleate, dibutyltin benzylmaleate, diphenyltin diacetate, and mixtures thereof.

The metal alkoxides may be chosen from the group consisting of titanium tetrabutoxide, titanium tetraisopropoxide, zirconium tetrabutoxide, zirconium tetraisopropoxide, and mixtures thereof.

The metal carboxylates may be chosen from the group consisting of zinc 2-ethylcaproate, zinc diacetate, zinc dineodecanoate, zinc diundecenoate, zinc dimethacrylate, cobalt acetylacetonate, cobalt diacetate, iron acetylacetonate, iron diacetate, nickel acetylacetonate, nickel diacetate, bismuth acetate, bismuth trioctanoate, bismuth dineodecanoate, zinc bismuth dineodecanoate, and mixtures thereof.

The metal coordination complexes with one or more organic ligands may be chosen from the group consisting of zinc acetylacetonate, titanium acetylacetonate (commercially available, for example, under the name Tyzor® AA75 from the company Dorf Ketal), titanium tetraacetylacetonate, aluminum trisacetylacetonate, aluminum chelates, for instance bis(ethyl acetoacetate) monoacetylacetonate (commercially available, for example, under the name K-KAT® 5218 from the company King Industries), zirconium tetraacetylacetonate, diisopropoxybis(ethylacetonato)titanium, and mixtures thereof.

### (D2) Amines:

The amines may be primary amines, secondary amines or tertiary amines.

Preferably, the amines are chosen from the group consisting of triethylamine, tributylamine, tetramethylguanidine, 1,8-diazabicyclo[5.4.0]-7-undecene, 1,4-diazabicyclo[2.2.2]octane, 1,5-diazabicyclo[4.3.0]non-5-ene, N,N-bis(N,N-dimethyl-2-aminoethyl)methylamine, N,N-dimethylcyclohexylamine, N,N-dimethylphenylamine, N-ethylmorpholine, and mixtures thereof.

### (D3) Acid Catalysts and Derivatives Thereof:

The acid catalysts may be chosen from inorganic acid catalysts, organic acid catalysts, and mixtures thereof.

Among the inorganic acid catalysts, examples that may be mentioned include phosphoric or orthophosphoric acid, phosphorous acid, hypophosphorous acid, or sulfuric acid.

The organic acid catalysts may be chosen from sulfonic acids, carboxylic acids, organophosphate acids, organophosphonate acids, phosphonic acids, and mixtures thereof.

Preferably, the organic and inorganic acid catalysts have a pKa of less than or equal to 6, preferably less than or equal to 4, advantageously less than or equal to 2, advantageously less than or equal to 0.

The sulfonic acids may be aliphatic or aromatic, optionally substituted (for example substituted with at least one substituent chosen from halogens (such as fluorine), hydroxyls, alkyls, amines, and mixtures thereof), and may be mono- or disulfonic.

The sulfonic acids may be chosen from N-alkylaminoalkylsulfonic acids and N,N-dialkylaminoalkylsulfonic acids (zwitterions), for instance 2-(N-morpholino)ethanesulfonic acid, 3-(N-morpholino)propanesulfonic acid, 4-[N-morpholino]butanesulfonic acid, 1,4-piperazinediethanesulfonic acid, N-2-hydroxyethylpiperazine-N′-2-ethanesulfonic acid, 2-(N-morpholino)ethanesulfonic acid, N-morpholinomethanesulfonic acid, N-(2-hydroxyethyl)piperazine-N′-methanesulfonic acid, piperazine-N,N′-bis(methanesulfonic acid), cyclohexylaminomethanesulfonic acid, N-[tris(hydroxymethyl)methyl]aminomethanesulfonic acid, N,N-bis(2-hydroxyethyl)aminomethanesulfonic acid; para-toluenesulfonic acid; benzenesulfonic acid; methanesulfonic acid; dodecylbenzenesulfonic acid; dodecylbenzenedisulfonic acid; dinonylnaphthalenedisulfonic acid; dinonylnaphthalenesulfonic acid; trifluoromethylsulfonic acid; and mixtures thereof.

In particular, the sulfonic acids are chosen from para-toluenesulfonic acid, benzenesulfonic acid, methanesulfonic acid, dodecylbenzenesulfonic acid, dodecylbenzenedisulfonic acid, dinonylnaphthalenedisulfonic acid, dinonylnaphthalenesulfonic acid, trifluoromethylsulfonic acid, and mixtures thereof.

Among the carboxylic acid catalysts, examples that may be mentioned include malonic acid, succinic acid, maleic acid, oxalic acid, acetic acid, lactic acid, benzoic acid, citric acid, glycolic acid, and mixtures thereof.

In the context of the invention, and unless otherwise mentioned, the term “organophosphate acid” means a phosphoric acid ester comprising at least one —OH radical.

For example, methyl phosphate is an organophosphate acid comprising two —OH radicals and has the following structure:

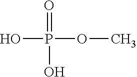

In particular, the organophosphate acids have the following formula:

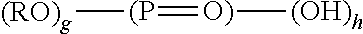

in which:
R is an organic radical, in particular a radical chosen from linear or branched C1-C22 alkyls, cycloalkyls, aryls, and mixtures thereof (said alkyl, cycloalkyl and aryl groups being optionally substituted); and
g and h are integers, with g+h=3 and h=1 or 2.

The organophosphate acids may be chosen, for example, from the group consisting of C1-C22 mono- or dialkyl phosphate acids and mixtures thereof, for instance butyl phosphate, dibutyl phosphate, bis(2-ethylhexyl) phosphate, 2-ethylhexyl phosphate, and mixtures thereof; mono- or diaryl phosphates, and mixtures thereof, for instance monophenyl phosphate, diphenyl phosphate and mixtures thereof; alkyl phenyl phosphates; and mixtures thereof.

In the context of the invention, and unless otherwise mentioned, the term “organophosphonate acid” means a phosphorus-based compound having the following general formula:

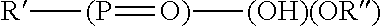

in which R′ and R″ are organic radicals, preferably chosen, independently of each other, from linear or branched C1-C22 alkyls, cycloalkyls, aryls, and mixtures thereof (said alkyl, cycloalkyl and aryl groups being optionally substituted).

Among the organophosphonate acids, examples that may be mentioned include C1-C22 monoalkyl phosphonate acids.

In the context of the invention, and unless otherwise mentioned, the term “phosphonic acid” means a phosphorus-based compound having the following general formula:

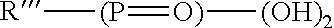

in which R′″ is an organic radical, preferably chosen from linear or branched C1-C22 alkyls, cycloalkyls, aryls, and mixtures thereof (said alkyl, cycloalkyl and aryl groups being optionally substituted).

Among the phosphonic acids, examples that may be mentioned include N-alkylaminoalkylphosphonic acids (zwitterions), N,N-dialkylaminoalkylphosphonic acids (zwitterions), C1-C20 alkylphosphonic acids, for instance methylphosphonic acid, ethylphosphonic acid, propylphosphonic acid, butylphosphonic acid, t-butylphosphonic acid, isobutylphosphonic acid, hexylphosphonic acid, 2-ethylhexylphosphonic acid and linear or branched higher homologs, benzylphosphonic acid, phenylphosphonic acid, tolylphosphonic acid or xylylphosphonic acid.

Examples of organic acid catalysts that may be mentioned include Nacure® 155 (dinonylnaphthalenedisulfonic acid, containing 55% active material in isobutanol) sold by King Industries, Nacure®1051 (dinonylnaphthalenesulfonic acid, containing 50% active material in 2-butoxyethanol) sold by King Industries, Nacure® 5076 (dodecylbenzenesulfonic acid, containing 70% active material in isopropanol) sold by King Industries, K-Cure® 1040 (para-toluenesulfonic acid, containing 40% active material in isopropanol) sold by King Industries, Nacure® 4000 (mixture of mono- and dialkyl phosphate acids, 100% active material) sold by King Industries.

The acid derivatives according to the invention may be acid anhydrides, acid esters or acid ammonium salts, the acid being as described above.

The acid derivatives are in particular “masked” or “latent” acids which advantageously make it possible to release the acid by thermal activation (for example at a temperature ranging from 70° C. to 170° C., preferably at a temperature ranging from 90° C. to 120° C.) or by hydrolysis, or by photoactivation, preferably by thermal activation. The masked acid advantageously makes it possible to release the acid which is the species having the catalytic activity. For example, the ammonium salt formed between aminomethylpropanol and para-toluenesulfonic acid is a masked acid (acid derivative) which, by thermal activation, releases the para-toluenesulfonic acid.

The acid derivatives may be prepared via any means known to those skilled in the art starting with the corresponding acid, for example by using typical acid/base reactions. For example, the process for making an ester typically involves the condensation of an acid compound with a compound comprising a hydroxyl group, for instance an alcohol, or with a compound of oxirane type. The ammonium salts may be prepared from any abovementioned acid, with ammonia or with a primary, secondary or tertiary amine. The amines may optionally comprise at least one functional group such as a hydroxyl group (alkanolamines), a C1-C4 alkyl group. The ammonium salts (zwitterions) may also be prepared by modifying the pH of a solution containing, for example, N-alkylaminoalkylphosphonic acids, N,N-dialkylaminoalkylphosphonic acids, N-alkylaminoalkylsulfonic acids or N,N-dialkylaminoalkylsulfonic acids.

Preferably, the catalyst is an ammonium salt of a sulfonic acid (the sulfonic acid being as described above), an ammonium salt of a phosphonic acid (the phosphonic acid being as described above), an ammonium salt of an organophosphonate acid (the organophosphonate acid being as described above), or an ammonium salt of an organophosphate acid (the organophosphate acid being as described above).

As amines for the preparation of the ammonium salts, examples that may be mentioned include 2-amino-2-methyl-1-propanol, triethylamine, aniline, pyridine, dimethylaminoethanol, alkypyridines, diisopropanolamine, dimethylethanolamine, triethanolamine, oxazolidines, bicyclic oxazolidines, amidines, diazabicyclooctanes, guanidines, N-alkylmorpholines, aminopyridines, aminoalkylpyridines, aminopyrrolidines, indazole, imidazole, pyrazole, pyrazine, pyrimidine, purine, imidazoline, pyrazoline, piperazine, aminomorpholine, aminoalkylmorpholines, and mixtures thereof. Preferably, the amines are tertiary amines.

Examples of acid derivatives that may be mentioned include Nacure®3327 or Nacure® 3525 (dinonylnaphthalenedisulfonic acid masked with an amine, containing 25% active material in isopropanol and isobutanol) sold by King Industries, Nacure® 1557 or Nacure® 1953 (dinonylnaphthalenesulfonic acid masked with an amine, containing 25% active material in a mixture of butanol and 2-butoxyethanol) sold by King Industries, Nacure® 5225 or Nacure® 5528 or Nacure® 5925 (dodecylbenzenesulfonic acid masked with an amine, containing 25% active material in isopropanol) sold by King Industries, Nacure® 2107 or Nacure® 2500 (para-toluenesulfonic acid masked with an amine, containing 25% or 26% active material in isopropanol) sold by King Industries, Nacure® 2501 or Nacure®2530 (para-toluenesulfonic acid masked with an amine, containing 25% active material in a mixture of isopropanol and methanol) sold by King Industries, Nacure® 4167 (dialkyl phosphate masked with an organic amine, containing 25% active material in a mixture of isopropanol and isobutanol) sold by King Industries, Nacure® 4575 (phosphate acid blocked with an amine, containing 25% active material in a mixture of methanol and butanol) sold by King Industries.

Preferably, the catalyst is chosen from the group consisting of organometallic compounds, and more preferentially from the group consisting of metal alkoxides.

The composition according to the invention may comprise from 0.001% to 5% by weight, preferably from 0.01% to 3% by weight and even more preferentially from 0.05% to 1% by weight of catalyst (D) relative to the total weight of said composition.

### Other Additives

The moisture-crosslinkable adhesive composition according to the invention may also comprise one or more additives chosen from the group consisting of moisture absorbers, plasticizers, antioxidants, pigments, colorants, adhesion promoters, UV stabilizers, solvents, flame-retardant additives or fillers.

The humidity absorber (or desiccant) may be chosen, for example, from non-polymeric hydrolyzable alkoxysilane derivatives, with a molecular mass of less than 500 g/mol, preferably chosen from trimethoxysilane and triethoxysilane derivatives. Such an agent can typically extend the shelf life of the composition during storage and transportation before it is used. Mention may be made, for example, of γ-methacryloyloxypropyltrimethoxysilane (for example available under the trade name Silquest® A-174 from Momentive), methacryloyloxymethyltrimethoxysilane (for example available under the name Geniosil® XL33 from Wacker), vinyltrimethoxysilane, isooctyltrimethoxysilane or phenyltrimethoxysilane.

The content of moisture absorber is preferably less than or equal to 3% by weight, more preferably less than or equal to 2% by weight, relative to the total weight of composition A. When it is present, the moisture absorber may represent, for example, from 0.1% to 3% by weight or from 1% to 2% by weight relative to the total weight of the composition according to the invention.

The composition according to the invention may also comprise a plasticizer.

As examples of plasticizers that may be used, mention may be made of any plasticizer usually used in the field of adhesives, for instance phthalates, benzoates, trimethylolpropane esters, trimethylolethane esters, trimethylolmethane esters, glycerol esters, pentaerythritol esters, naphthenic mineral oils, adipates, cyclohexyldicarboxylates, liquid paraffins, natural oils (optionally epoxidized), polypropylenes, polybutylenes, hydrogenated polyisoprenes, and mixtures thereof.

Mention may be made, among the phthalates, for example, of diisononyl phthalate, diisobutyl phthalate, dioctyl phthalate, dicyclohexyl phthalate, diisooctyl phthalate, diisododecyl phthalate, dibenzyl phthalate or butyl benzyl phthalate.

Mention may be made, among the benzoates, for example, of: neopentyl glycol dibenzoate (for example available under the name Uniplex® 512 from Lanxess), dipropylene glycol dibenzoate (for example available under the name Benzoflex® 9-88SG from Eastman), a mixture of diethylene glycol dibenzoate and of dipropylene glycol dibenzoate (for example available under the name K-Flex® 850 S from Kalama Chemical) or else a mixture of diethylene glycol dibenzoate, of dipropylene glycol dibenzoate and of triethylene glycol dibenzoate (for example available under the name Benzoflex® 2088 from Eastman).

Among the pentaerythritol esters, examples that may be mentioned include pentaerythrityl tetravalerate (available, for example, under the name Pevalen™ from the company Perstorp).

Among the cyclohexanedicarboxylates, mention may for example be made of diisononyl 1,2-cyclohexanedicarboxylate (available, for example, under the name Hexamoll Dinch® from BASF).

The total content of plasticizer(s) in the composition according to the invention can range from 0% to 30% by weight, preferably from 0% to 30% by weight, indeed even, for example, from 0% to 15% by weight, relative to the total weight of said composition. Preferably, the composition does not comprise any plasticizer.

The composition according to the invention may also comprise an antioxidant (also denoted by the term UV stabilizer).

Antioxidants are compounds that can be introduced to protect the composition from degradation resulting from a reaction with oxygen which is liable to be formed by the action of heat or light. These compounds may include primary antioxidants that scavenge free radicals. The primary antioxidants may be used alone or in combination with other secondary antioxidants or UV stabilizers.

Mention may be made, for example, of Irganox®1010, Irganox® B561, Irganox®245, Irganox® 1076 or Irgafos® 168, which are sold by BASF.

An amount of antioxidant ranging from 0.1% to 3%, preferably from 1% to 3% by weight, on the basis of the total weight of the composition according to the invention is generally used.

The solvents are preferably non-reactive solvents.

Among the solvents, mention may be made, for example, of polyols, alcohols, esters, ketones, and mixtures thereof.

The polyols may be chosen from diols, triols, and mixtures thereof. Preferably, they are polyester polyols, for instance those described previously.

Preferably, the composition according to the invention comprises a content of carbonate-based filler of less than or equal to 15% by weight, more preferentially less than or equal to 10% by weight and even more preferentially less than or equal to 5% by weight, relative to the total weight of said composition.

More preferably, the composition comprises less than 2% by weight of carbonate-based filler relative to the total weight of said composition, and in particular it does not comprise any carbonate-based filler.

Preferably, the composition does not comprise any (meth)acrylate polymer.

Preferably, the composition contains less than 10% by weight of additives.

The composition according to the invention is advantageously a pressure-sensitive adhesive (PSA) composition.

The adhesive composition according to the invention advantageously leads, after crosslinking, to good adhesive properties at 23° C. at the initial stage, but also to good resistance to aging, notably under constraining temperature and humidity conditions.

The composition according to the invention advantageously has a high resistance to wet poultice.

The adhesive composition according to the invention preferably has, after crosslinking, an adhesive strength at 180° (peel at 180°) at 23° C. of greater than or equal to 0.4 N/cm, determined according to the FINAT method No. 1 of 2001, preferably with a PET support.

The adhesive composition according to the invention may be in the form of a one-component adhesive composition or a multicomponent, preferably two-component, adhesive composition.

### I. One-Component Adhesive Composition:

According to a first embodiment, the adhesive composition according to the invention is in the form of a one-component composition.

According to this embodiment, said one-component composition preferably comprises:
from 5% to 80% by weight, preferably from 15% to 70% by weight, preferentially from 20% to 60% by weight, of at least one silyl polymer (A);
from 15% to 90% by weight, preferably from 30% to 80%, preferentially from 40% to 70% by weight of at least one tackifying resin (B);
from 1% to 50% by weight, preferably from 4% to 40% by weight, preferentially from 5% to 20% by weight of at least one compound (C); and
from 0% to 10%, preferably from 0.001% to 5%, preferentially from 0.01% to 3%, by weight of crosslinking catalyst (D);
these weight percentages being indicated on the basis of the total weight of one-component composition.

The one-component composition may be prepared via a process which comprises:
a step of mixing, with the exclusion of air and moisture, preferably under an inert atmosphere, the polymer(s) (A) with the tackifying resin(s) (B), and the compound(s) (C), at a temperature of between 50° C. and 180° C., preferably between 100° C. and 160° C., and then
a step of cooling said mixture to a temperature ranging from 50° C. to 130° C., and advantageously from about 70° C. to 90° C., and then
a step of incorporating into said mixture an optional crosslinking catalyst (D) and, where appropriate, the other optional additives.

### II. Multicomponent Adhesive Composition:

According to a second embodiment, the adhesive composition according to the invention is in the form of a multicomponent composition comprising:
a composition U (as first component) comprising:
   the silyl polymer(s) (A) as defined previously; and
   the tackifying resin(s) (B) as defined previously;
   optionally, the compound(s) (C) as defined previously; and
a composition V (as second component) comprising:
   the compound(s) (C) as defined previously;
the optional catalyst (D) being contained in composition V or alternatively in a composition W (third component).

The various components of said multicomponent adhesive composition are intended to be mixed at the time of performing the crosslinking reaction, in accordance with the process for manufacturing a self-adhesive support described below.

The multicomponent adhesive composition may comprise one or more additional compositions in addition to compositions U and V, said additional composition(s) possibly comprising compound(s) of any type. For example, the multicomponent adhesive composition may comprise an additional composition W comprising water. The water may be in liquid or gaseous form, or encapsulated, or absorbed, or contained in the chemical structure of a component. The water may be derived from one or more components which may subsequently render it free and available.

Compositions U and V included in said adhesive composition (before mixing) are advantageously stable on storage, with respect to temperature and/or to moisture. The greater stability over time advantageously allows longer storage and handling with a reduced risk of reaction, degradation or crosslinking of compositions U and V, between their production and their hot application.

The multicomponent adhesive composition according to the invention advantageously allows the formation of a uniform adhesive layer which does not have any problem of uncontrolled and non-homogeneous formation of grains or gels, and/or advantageously allows uniform crosslinking over the entire support layer.

According to an even more preferred embodiment, the multicomponent adhesive composition according to the invention is a two-component adhesive composition consisting of the abovementioned compositions U and V.

### Kit

The present invention also relates to a kit comprising at least the abovementioned composition U and composition V in two separate compartments. The compartments may be, for example, drums, cartridges or bags. When the multicomponent composition comprises other compositions (for instance a composition W), the latter are contained in other compartments of the kit.

### Self-Adhesive Article

A subject of the present invention is also a self-adhesive article comprising a support layer coated with a self-adhesive layer, characterized in that said self-adhesive layer consists of the adhesive composition according to the invention in cured form.

For the purposes of the present invention, the term “self-adhesive article” includes any article that can be adhesively bonded to a surface solely by the action of pressure with the hand or an item of equipment, without the use of additional glues or adhesives.

The self-adhesive article is a pressure-sensitive self-adhesive article.

The support layer coated with a self-adhesive layer is also denoted by the term “self-adhesive support”.

These articles notably have the aim of being applied to a surface to be bonded so as to bring together, hold together, fix, or simply immobilize, expose forms, logos, images or information. These articles may be used in many fields, such as the medical field, clothing, packaging, motor vehicles (for example for attaching logos, lettering, interior soundproofing, interior trim, adhesive bonding in the passenger compartment) or construction (for example for sound and thermal insulation, the assembling of windows). They may be fashioned as a function of their final application, for example in the form of tapes, such as tapes for industrial use, tapes for do-it-yourself work or for fixing use on worksites, single-sided or double-sided tapes, or in the form of labels, bandages, dressings, patches or graphic films.

According to one embodiment, the self-adhesive article is a self-adhesive multilayer system, and in particular a self-adhesive label or tape, which can be single-sided or double-sided.

The material which can be used for the support layer can, for example, be any type of rigid or flexible support. Mention may be made, for example, of supports of the type of foams, felts, nonwoven supports, plastics, membranes, papers or a film of a polymer material having one or more layers, in particular a nonstick protective paper or plastic film.

The support layer is made of a material chosen, for example, from polyolefins, such as polyethylene, including high-density polyethylene, low-density polyethylene, linear low-density polyethylene and linear ultra-low-density polyethylene; polypropylene and polybutylenes; polystyrene; natural or synthetic rubber; vinyl copolymers, such as polyvinyl chloride, which may or may not be plasticized, and poly(vinyl acetate)s; olefinic copolymers, such as ethylene/methacrylate copolymers, ethylene/vinyl acetate copolymers, acrylonitrile/butadiene/styrene copolymers and ethylene/propylene copolymers; acrylic polymers and copolymers; polyurethanes; polyethers; polyesters; and mixtures thereof. Preferably, the support layer is based on acrylic polymers, polyethylene (PE), polypropylene (PP), which may be oriented, nonoriented or biaxially oriented, polyimide, polyurethane, polyester, such as polyethylene terephthalate (PET), or paper.

According to one embodiment, the self-adhesive article obtained from the adhesive composition according to the invention comprises a permanent support layer coated with an adhesive layer. Preferably, the adhesive layer is in addition coated with a nonstick protective paper or plastic film, which is preferably silicone-treated.

According to another embodiment, the self-adhesive article obtained from the adhesive composition according to the invention comprises a nonpermanent support layer which consists of a first nonstick protective paper or plastic film, which is preferably silicone-treated, said layer being coated with an adhesive layer, which can itself also be coated with a second nonstick protective paper or plastic film. This embodiment is particularly suitable for the assembly of windows by bonding, more particularly for the assembly of the rigid panel consisting of the double or triple glazing with the window frame. According to this embodiment, said non-permanent support layer is intended to be removed by the user at the moment of applying the self-adhesive article for the purpose of assembling the window.

As an alternative to the nonstick protective film, the rear face of the permanent support layer, which is not coated with the adhesive layer, can have a nonstick surface, for example a silicone-treated protective layer.

According to another embodiment, the permanent support layer is coated on both its faces with an adhesive composition, which can be identical or different, at least one of the two adhesive compositions being according to the invention, advantageously resulting in the manufacture of “double-sided” tapes.

Preferably, the support layer has a thickness ranging from 10 microns to 50 mm, more preferably ranging from 10 microns to 20 mm, preferably ranging from 20 microns to 10 mm, more preferably ranging from 20 microns to 1 mm.

In certain specific cases, it is necessary to carry out a surface treatment on the support layer in order to enhance the attachment of the adhesive layer during the stage of coating thereon.

The self-adhesive article according to the invention can thus adhesively bond two substrates. The substrate onto which the self-adhesive article is intended to be applied (denoted by “substrate to be adhesively bonded”) can be flexible or rigid. In particular, it can exhibit the same flexibility properties as the support layer described above, so as to be wound and packaged in the form of a reel, for example as described above.

Alternatively, the substrate to be adhesively bonded can be rigid. In this case, the substrate cannot be wound and packaged in the form of a reel, for example as described above. The substrate to be adhesively bonded can be chosen, for example, from concrete, paper, substrates of polyolefin type, glass, ceramic and metals, in particular aluminum.

The self-adhesive layer, which consists of the adhesive composition according to the invention in the crosslinked state and which covers the support layer in the self-adhesive article according to the invention, can have a very variable thickness, ranging from 10 μm to 5000 μm, preferably.

A thickness ranging from 10 μm to 100 μm and preferably from 20 to 50 μm is more particularly preferred in the case of self-adhesive labels, whereas a thickness ranging in a much broader interval of from 3 to 5000 μm may be encountered for self-adhesive tapes.

According to one embodiment, the self-adhesive article additionally comprises a protective nonstick layer (release liner).

According to one embodiment, said nonstick layer is applied to the adhesive layer, after crosslinking of the adhesive composition.

The support layer may be covered on one of its two faces, the rear face which is not coated with the adhesive layer, with a protective nonstick layer, for example with a silicone film. In this way, the self-adhesive article can be wound up on itself and then unwound without any problem by virtue of the absence of adhesion of the adhesive layer to the silicone-treated face.

### Process for Manufacturing the Self-Adhesive Article

A subject of the present invention is also a process for manufacturing the self-adhesive article as defined previously, said process being characterized in that it involves:
(a) preheating to a temperature of between 4° and 130° C. of the moisture-crosslinkable adhesive composition, as defined previously;
(b) applying said composition by coating onto a bearing surface;
(c) crosslinking said composition, by heating to a temperature ranging from 50 to 200° C.; and then
(d) laminating or transferring the layer of cured adhesive composition onto a support layer or onto a nonstick protective film.

When the adhesive composition is, in accordance with the first embodiment described in point I, a one-component composition, it is said one-component composition which is, in accordance with step (a), preheated and then, in accordance with step (b), applied to the bearing surface and, finally, in accordance with step (c), crosslinked.

When the heat-crosslinkable adhesive composition is, in accordance with the second embodiment described in point II, a multicomponent composition and preferably a two-component composition, the preheating in accordance with step (a) relates to at least composition U, and optionally composition V, depending on the nature of the ingredients present in said composition V.

The preheating step (a) is then followed by a step (a′) of mixing compositions U and V at a temperature ranging from 40 to 130° C., the composition resulting from the mixture formed then being applied, in accordance with step (b), to the bearing surface, and then cured in accordance with step (c).

For the purposes of the present invention, the term “bearing surface” should be understood as meaning either a belt conveyor coated with a nonstick layer, or a nonstick protective film (“release liner”), or a support layer.

In the case where the bearing surface is a nonstick protective film, the process for manufacturing the self-adhesive article according to the invention may comprise step (d) of transferring the crosslinked adhesive layer onto a support layer.

In the case where the bearing surface is a support layer or a nonstick protective film, the process for manufacturing the self-adhesive article according to the invention may also comprise step (d) of laminating the adhesive layer onto a nonstick protective film.

According to a preferred variant of the invention, step (d) of the process described above consists in transferring the crosslinked adhesive layer onto a flexible support layer (which may be a plastic film) after cooling of the crosslinked adhesive layer to a temperature below the degradation temperature or softening point of the material of which the support layer is composed.

According to one embodiment, the process for manufacturing the self-adhesive article according to the invention also comprises a step (e) of coating a second layer of adhesive composition according to the invention onto the support layer followed by a step (f) of crosslinking the adhesive composition coated in step (e) by heating to a temperature ranging from 20 to 200° C. According to this embodiment, a double-sided self-adhesive article is obtained.

The coating step (b) may be performed by means of known coating devices, for instance a lip nozzle or a nozzle of curtain type, or else with a roller. It uses a weight per unit area of adhesive composition ranging from 10 g/m² to 5000 g/m².

The weight per unit area of adhesive composition necessary for the manufacture of self-adhesive labels can range from 10 to 100 g/m², preferably from 20 to 50 g/m². The weight per unit area required for the manufacture of self-adhesive tapes may vary within a much wider range extending from 3 to 5000 g/m², preferably from 15 to 250 g/m² per face.

According to one embodiment, the coated adhesive composition is also subjected, during step (c), to a treatment under a humid atmosphere characterized by its moisture level and, in particular, in a gaseous environment in which water molecules are present at between 10 and 200 g per m³ of gas.

Preferably, the humid atmosphere is an atmosphere in which from 2% to 100% of the molecules are water molecules, preferably from 3% to 50%, more preferably from 3% to 10%, of the molecules are water molecules.

The moisture content is expressed as percentage of water per unit of volume, which corresponds to the number of water molecules divided by the total number of molecules in a unit of volume. By virtue of the linear nature of this scale, the moisture content is readily measured and monitored by using, for example, monitors of P.I.D (Proportional-Integral-Derivative) type. The percentage by weight can be calculated by multiplying the percentage of the number of water molecules with respect to the total number of molecules by a factor of 0.622. General information regarding the moisture content in various environments is described by W. Wagner et al. in “International Steam Tables—Properties of Water and Steam based on the Industrial Formulation IAPWS-IF97′.

The thermal crosslinking step has the effect notably of creating—between the polymer chains bearing hydrolyzable alkoxysilane end groups of the adhesive composition and under the action of atmospheric moisture and optionally of a crosslinking agent—bonds of siloxane type which lead to the formation of a three-dimensional polymer network. The adhesive composition thus crosslinked is in particular a pressure-sensitive adhesive which gives the support layer which is coated with it the desirable adhesiveness and the desirable tack.

Preferably, the coating is carried out uniformly over the support layer or over the nonstick protective layer but the coating can also be adapted to the desired shape of the final self-adhesive article.

According to one embodiment, the coating with the adhesive composition is carried out over at least a portion of the two faces of the support layer. If the two faces of the support layer are coated, the adhesive composition can be identical or different on the two faces and the weight per unit area can be identical or different on the two faces.

According to one embodiment of the invention, the self-adhesive article comprises an adhesive layer on at least a portion of a face or on at least a portion of the two faces of the support layer, said adhesive layer(s) being optionally coated with a nonstick protective layer.

According to one embodiment, the self-adhesive article comprises two nonstick protective layers on each of the two adhesive layers. In this case, the two protective layers can be made of identical or different materials and/or they can have an identical or different thickness.

According to a preferred variant of the process for manufacturing the self-adhesive article according to the invention, using the multicomponent adhesive composition as defined previously, step (b) of application by coating onto the bearing surface, for example onto the support layer (96), is performed by means of a facility for hot application (20) of said adhesive composition, the facility comprising:
a nozzle (50) for applying the multicomponent adhesive composition;
a line (88a) for feeding composition U included in the multicomponent adhesive composition to be applied in fluid form;
a line (66a) for feeding composition V included in the multicomponent adhesive composition to be applied in fluid form;
a line (88) for feeding the nozzle (50) with the multicomponent adhesive composition to be applied in fluid form; and
a mixer (30) for mixing at least compositions U and V of the multicomponent adhesive composition;
said step (b) involving:
   supplying the feed line (88a) with at least composition U;
   supplying the feed line (66a) with at least composition V;
   mixing at least composition U and composition V of the multicomponent composition using a mixer (30); and
   hot application of the mixed multicomponent adhesive composition (80) onto a support layer with the aid of the application nozzle (50).

The mixer may be a static mixer or a dynamic mixer.

Preferably, the static or dynamic mixer must be able to be temperature-regulated.

Preferably, the mixer (30) is a dynamic mixer, advantageously allowing mixing at high shear, and the obtention of better homogeneity of the adhesive composition resulting from the mixing of at least compositions U and V of the multicomponent composition.

The mixer (30) may be arranged between the lines for feeding at least composition U (88a) and composition V (66a), and the feed line (88), and may allow homogeneous mixing of the compositions constituting the multicomponent, notably two-component, adhesive composition.

The process according to the invention comprises the mixing of at least composition U and composition V of the multicomponent composition using a mixer (30). The mixing step may be a step of mixing composition U with composition V, and optionally with one or more additional compositions of the multicomponent composition (for example a composition W).

The facility may comprise heating means (44) suitable for being placed in a storage reservoir (82) comprising composition U or composition V or another additional composition of the multicomponent composition, to raise said composition to a pumping temperature; preferably, at least composition U is raised to a pumping temperature of between 50° C. and 140° C., preferably between 80° C. and 120° C., more preferentially between 90° C. and 110° C.

Preferably, the multicomponent adhesive composition is applied (after mixing at least compositions U and V) at a temperature of between 50° C. and 140° C., preferably between 60° C. and 120° C., more preferentially between 75° C. and 110° C.

FIG. 1 shows a schematic representation of one embodiment of a facility 20 capable of performing the process for manufacturing the self-adhesive article according to the invention.

According to one embodiment, as a result of the at least double supply, composition V (66) is separated from composition U (68) up to the mixer (30) placed between the lines for feeding at least compositions U (88a) and V (66a), on the one hand, and the line (88) for feeding the multicomponent adhesive composition to be applied, on the other hand. In other words, the mixer (30) is in-line and allows a step of homogeneous mixing of compositions (66) and (68) supplied separately to be performed. The injection of composition V (66) into composition U (68) is performed in the mixer (30), as illustrated, for example, in FIG. 1, to allow immediate mixing of these compositions.

The various compositions constituting the multicomponent adhesive composition according to the invention may be totally separated, i.e. each composition is supplied separately to the hot application facility (20). In particular, the injection of composition U (68), of composition V (66) and of optional additional composition(s) of the multicomponent adhesive composition is performed in the mixer (30).

In the facility according to the invention, composition U (68) may be heated in the storage reservoir (82) by means of a heating means (44), without bringing about crosslinking of composition U (68) due to the separation from composition V (66), comprising at least the crosslinking catalyst. Heating in the storage reservoir (82), preferably represented in the form of a drum, in particular makes it possible to reduce the viscosity of composition U (68), to facilitate the pumping in the facility (20), such as with the aid of a pump (46), before any contact with the separate composition V (66).

This heating means (44) (preferably being a hotplate) notably contributes toward bringing composition U (68) to the application temperature. The application temperature notably corresponds to a temperature at which the adhesive composition to be applied has a viscosity that is low enough to allow the application, in other words the coating, of the mixed multicomponent adhesive composition (80) onto the surface (96).

Specifically, after mixing compositions V (66) and U (68), the multicomponent adhesive composition (80) is constituted and can be applied hot to the support (96) with the aid of an application nozzle (50). A temperature for applying the multicomponent adhesive composition (80) may thus correspond to a temperature at which the viscosity of the multicomponent adhesive composition is less than or equal to 50 Pa·s, preferably less than or equal to 10 Pa·s. By way of example, the multicomponent adhesive composition (80) may have a viscosity of 5±1 Pa·s at an application temperature ranging from 60° C. to 120° C. Following the application of the multicomponent adhesive composition (80) to the surface (96), the coated support (98) is subjected to a controlled temperature, and optionally to a controlled moisture level, to allow the crosslinking of the multicomponent adhesive composition.

The controlled temperature may be obtained with the aid of an oven or a chamber.

The controlled temperature corresponds to a temperature of crosslinking of the multicomponent adhesive composition (80) and is, for example, between 50° C. and 200° C., preferably between 80° C. and 160° C., in particular between 100° C. and 150° C.

Similarly, composition V (66) may itself also be heated before it is mixed with composition U (68) without any risk of crosslinking before they are mixed. This is likewise the case for any composition of the multicomponent composition according to the invention.

The heating of all of the separate compositions V (66) and U (68) before mixing them notably makes it possible to bring these components to the application temperature without any risk of crosslinking before they are mixed in the mixer (30).

The self-adhesive article according to the invention may finally be used in an adhesive bonding method which is also a subject of the invention, characterized in that it involves the following steps:
a) removing the nonstick protective layer, when such a layer is present;
b) applying the self-adhesive article to a surface of a product; and
c) applying a pressure to said article.

In step b), the self-adhesive article is applied so that the self-adhesive part of the article (formed by the self-adhesive layer) is facing the surface of the product.

According to an embodiment in which the self-adhesive article is a double-sided article, the adhesive bonding method also comprises a step in which either a second surface of a product is applied to the article bonded to the first surface of a product, or the article bonded to the first surface of a product is applied to a second surface of a product.

### Uses

The present invention also relates to the use of a compound (C) as defined above, in an adhesive composition comprising:
a silyl polymer (A) as defined above;
a tackifying resin (B) as defined previously;
for improving the resistance to aging of the composition after crosslinking.

The ingredients and features (including preferred embodiments) described above for the composition also apply for the abovementioned use, without the need to repeat everything.

In the context of the invention, the term “between x and y” or “ranging from x to y” means a range in which the limits x and y are included. For example, the range “between 1% and 10%” notably includes the values 1% and 10%.

The examples that follow illustrate the invention without, however, limiting it.

### EXPERIMENTAL SECTION

The following products were used:
Geniosil® STP-E30, available from Wacker: polypropylene glycol capped with two alpha silane functions of methyl dimethoxy type, with a number-average molecular mass of about 24 000 g/mol;
Dertophene® T105, available from DRT: tackifying resin of terpene phenolic type;
Irganox® 1010, available from BASF: antioxidant of hindered phenol type;
Irganox® 245, available from BASF: antioxidant of hindered phenol type;
TES 40WN: tetraethoxyorthosilicate from Wacker;
Tyzor TNBT: titanium butoxide, M=340 g/mol, from the company Dorf Ketal;
XL 33: moisture absorber sold by Wacker.

### Measurement of the Ta:

The glass transition temperature (Tg) was determined by Dynamic Mechanical Analysis (DMA).

The following conditions were used:
the T-scans (1 Hz) are performed on an MCR302 rheometer from Anton Paar, equipped with a CTD450 oven. Liquid nitrogen may be used as gas.
the sample consists of a monolayer of 500 gsm of the adhesive composition after aging for 7 days at 50° C.;
10 mm parallel plates are used;
a gap is defined by the thickness of the sample, between 500 and 1000 microns,
the samples are placed at 40° C. in the rheometer with a pressure of between 1 and 2 N;
the temperature ramp is as follows:
   Interval 1: insertion at 40° C., pressure 1 N;
   Interval 2: cooling to −40° C., pressure 0.5 N;
   Interval 3: stabilization at −40° C. for 1 min;
   Interval 4: heating at 5° C./min up to −10° C. (oscillation at 0.005%, 1 Hz, 0 N);
   Interval 5: heating at 5° C./min up to 150° C. (oscillation at 0.005%, 1 Hz, 0 N).

### Example 1: Preparation of the Reference Composition C1

Composition C1 of Table 1 is prepared in two steps.

### 1. Part A

Part A of composition C1 is prepared by first introducing the Dertophene® T105 tackifying resin into a glass reactor and mixing with the antioxidant for about one hour (temperature rise time of the reactor and incorporating at least 30 minutes at a temperature 15-40° C. above the softening point of the tackifying resin, i.e. about 130° C.) Then, once the resin has fully melted, part of the Geniosil® STP-E30 (silane-modified polymer) is added at 140° C. under vacuum (0 mbar). The temperature is then reduced by 20° C., before the addition of the second portion of Geniosil® STP-E30. The mixture is then gradually cooled to 90° C. under vacuum to extract any trace of water and avoid hydrolysis of the silane-modified polymer. The polymer additions are performed under a stream of nitrogen.

The mixture is stirred under vacuum for 10 minutes and then cooled for storage in a cartridge before use.

### 2. Preparation of Composition C1

Composition C1 is prepared by preheating part A above to 100° C. for at least 30 minutes. The catalyst Tyzor TNBT is then added with stirring (2000 rpm) over 5 minutes.

Composition C1 is detailed in Table 1 below.

### Example 2: Preparation of Composition C2 (Invention)

Composition C2 is prepared according to the same protocol as reference composition C1 (Example 1), with the difference that TES40WN is added with the catalyst Tyzor TNBT (without initial premixing).

Composition C2 is detailed in Table 1 below.

### Example 3: Preparation of a PET Support Layer Coated with the Crosslinked Composition, at a Weight Per Unit Area of 60 q/m²

A rectangular sheet of silicone-treated PolyEthylene Terephthalate (PET) (nonstick layer) with dimensions of 21 cm by 29.7 cm is used as support layer.

Composition C1 (or C2) is preheated to a temperature close to 100° C. and is introduced into a cartridge, from where a bead is extruded which is deposited close to the edge of the sheet parallel to its width.

The composition included in this bead is then spread over the whole surface of the sheet, so as to obtain a uniform layer of substantially constant thickness. A film spreader (also known as a film applicator) is used to do this, and is moved from one edge of the sheet to the opposite edge. A layer of composition corresponding to a weight per unit area of 60 g/m² is thus deposited, representing an approximate thickness of the order of 60 μm.

The PET sheet thus coated is then placed in an oven at 140° C. and under a humid atmosphere (2.4% relative humidity) for 5 minutes for crosslinking of the composition, and is then laminated onto a PolyEthylene Terephthalate (PET) layer of thickness 50 μm (Mylar) and with dimensions of 21 cm by 29.7 cm, consisting of a sheet of rectangular silicone-treated film having the same dimensions.

The triple layer obtained is subjected to the three tests described below.

At the end of crosslinking of the coating, the latter covered with a release liner (anti-adhesive protection) is placed either at 23° C. or in an oven at 50° C. for 7 days (to evaluate the final performance of the coating whose crosslinking has been optimized). 180° peel test on a stainless-steel plate:

The adhesive power is evaluated by the 180° peel test on a stainless-steel plate, as described in the FINAT method No. 1, published in the FINAT Technical Handbook, 6^{th} edition, 2001. FINAT is the International Federation of Self-Adhesive Label Manufacturers and Converters.

The principle of this test is as follows:

A test specimen in the form of a rectangular strip (2.54 cm×15 cm) is cut out from the triple layer obtained previously.

It is then attached over half its length (after removal of the corresponding portion of protective nonstick layer) to a substrate consisting of a stainless-steel plate. The assembly obtained is left at room temperature (23° C.) for 10 minutes (dwell time or wetting time). It is then placed in a tensile testing device capable, starting from the end of the rectangular strip which has remained free, of carrying out the peeling or detachment of the strip at an angle of 180° and with a separation speed of 300 mm per minute. The instrument measures the force required to detach the strip under these conditions.

The corresponding result is expressed in N/cm and indicated in Table 1.

### Evaluation of Heat Resistance—“SAFT” Test Method on Stainless Steel:

The temperature-related adhesion of the adhesive power is evaluated by the test of determination of the temperature resulting in the failure of the adhesive seal with static shearing. This test is also known as the Shear Adhesion Failure Temperature (or SAFT) test. A test specimen in the form of a square strip (2.54 mm×7.5 mm) is cut out in each from the triple layer obtained previously. After removing the entire protective layer (or “release liner”), a 2.54 cm square section at the end of the adhesive strip is attached to a sanded stainless steel plate, with the non-adhesive part of the strip (5 cm long) located below the plate. After thermal equilibration at 23° C. for 1 h, the test plate thus obtained is placed, by means of a suitable support, in a substantially vertical position (2° with respect to the vertical) in an oven at 23° C. The free part of the strip is connected to a mass of 1 kg, the whole device then remaining in the oven for the duration of the test. The SAFT value is subsequently measured in accordance with the Finat 8 test method with a rise in temperature of the oven of 0.5° C. per minute. The temperature at which the strip detaches from the plate following the failure of the adhesive seal under the effect of this stress is recorded.

### Shear Strength Test at 125° C. On Stainless Steel

The internal cohesion of the adhesive is evaluated by the shear test at 125° C.

The preparation of the specimen is done exactly as for a SAFT. The difference of the shear 125° C. compared to the SAFT lies in the fact that the sample subjected to a weight of 1 kg is placed in an oven at a temperature controlled at 125° C. The result of the shear test corresponds to the resistance time at the stress (weight and temperature) before the weight is no longer retained by the adhesive.

The time at the end of which the strip detaches from the plate following the failure of the adhesive seal under the effect of this stress is recorded.

The results are expressed in Table 1 below for different aging temperatures (23° C. or 50° C. for 7 days):

| | |
|---|---|
| Composition C1 | Composition |
| (Reference- | C2 |
| Comparative) | (invention) |

Composition (wt %)

| | | |
|---|---|---|
| Dertophene T105 | 54.14 | 48.72 |
| Irganox 1010 | 0.45 | 0.40 |
| Irganox 245 | 0.45 | 0.40 |
| TES 40WN | / | 10 |
| STP-E30 | 44.31 | 39.87 |
| XI 33 | 0.4 | 0.36 |
| TnBT | 0.25 | 0.25 |
| | 100 | 100 |
| Results | | |

7 days at 23° C.

| | | |
|---|---|---|
| 180° peel (N/cm) | 9.68 | 5.8 |
| Shear/shear strength at | 24.3 | 131.3 |
| 125° C. (in hours)-1 kg | | |
| SAFT (° C.)-1 kg | 181° C. | >200° C. |
| Tg (° C.) Tscan 1 Hz | −2.5 | 1.6 |

7 days at 50° C.

| | | |
|---|---|---|
| Shear/shear strength at | 28.8 | 141 |
| 125° C. (in hours)-1 kg | | |
| SAFT (° C.)-1 kg | 183° C. | >200° C. |

It emerges from this table that composition C2 according to the invention advantageously provides a high shear strength (Shear) compared with the reference composition C1 (131 h for C2 compared with 24.3 h for C1), even after aging at 50° C.

The table also shows that the adhesive strip derived from composition C2 advantageously resists up to more than 200° C. compared with the adhesive strip derived from composition C1 (181/183° C.).

These results demonstrate good resistance of composition C2 to aging under constraining conditions of temperature and humidity.

The claims are amended as follows:

1-16. (canceled)

17. A moisture-crosslinkable adhesive composition comprising:
at least one silyl polymer (A);
a tackifying resin (B);
at least one compound (C) chosen from the group consisting of:
compounds of formula (F1) and oligomeric/polymeric derivatives thereof: 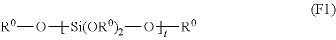
in which:
R⁰ is independently chosen from alkyls and aryls,
t represents an integer ranging from 1 to 20,
compounds of formula (F2): 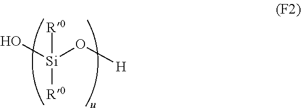
in which:
R′⁰ is independently chosen from alkyl groups comprising from 1 to 10 carbon atoms,
u is an integer ranging from 3 to 5000,
aminopolysiloxane compounds; and
mixtures thereof;
said composition being characterized in that it has a glass transition temperature ranging from −25° C. to 20° C.

18. The moisture-crosslinkable adhesive composition as claimed in claim 17, characterized in that it has a glass transition temperature ranging from −20° C. to 15° C.

19. The moisture-crosslinkable adhesive composition as claimed in claim 17, characterized in that the silyl polymer (A) corresponds to one of the formulae (II′), (III′) or (IV′): 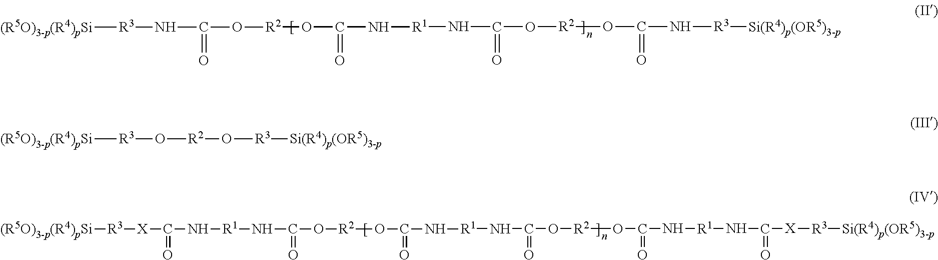
in which:
R¹ represents a divalent hydrocarbon-based radical comprising from 5 to 15 carbon atoms, which may be aromatic or aliphatic,
R³ represents a linear or branched divalent alkylene radical comprising from 1 to 6 carbon atoms,
X represents a divalent radical chosen from —NH—, —NR⁷— or —S—,
R⁷ represents a linear or branched alkyl radical comprising from 1 to 20 carbon atoms and which may also comprise one or more heteroatoms,
R⁴ represents a linear or branched alkyl group comprising from 1 to 4 carbon atoms, with the possibility that when there are several radicals R⁴, these radicals are identical or different;
R⁵ represents a linear or branched alkyl group comprising from 1 to 4 carbon atoms, with the possibility that when there are several radicals R⁵, these radicals are identical or different, with the possibility that two groups OR⁵ may be engaged in the same ring; and
p is an integer equal to 0, 1 or 2,
R² represents a saturated or unsaturated, linear or branched divalent hydrocarbon-based radical optionally comprising one or more heteroatoms, and
n is an integer greater than or equal to 0.

20. The moisture-crosslinkable adhesive composition as claimed in claim 19, characterized in that R² is a divalent radical derived from a polyether.

21. The moisture-crosslinkable adhesive composition as claimed in claim 17, characterized in that the tackifying resin (B) is chosen from terpene resins.

22. The moisture-crosslinkable adhesive composition as claimed in claim 17, characterized in that compound (C) is chosen from the compounds of formula (F1) and oligomeric/polymer derivatives thereof.

23. The moisture-crosslinkable adhesive composition as claimed in claim 22, characterized in that the compounds of formula (F1) and the oligomeric/polymeric derivatives thereof are those in which:
R⁰ is chosen from ethyl, n-propyl, butyl or isopropyl; and/or
t represents an integer ranging from 1 to 20.

24. The moisture-crosslinkable adhesive composition as claimed in claim 17, characterized in that the compound (C) is chosen from tetraethoxyorthosilicate, tetrapropoxyorthosilicate, tetraisopropoxyorthosilicate, tetrabutoxyorthosilicate, oligomeric/polymeric derivatives thereof, and mixtures thereof.

25. The moisture-crosslinkable adhesive composition as claimed in claim 17, characterized in that the composition comprises from 1% to 50% by weight of compounds (C), relative to the total weight of said composition.

26. The composition as claimed in claim 17, characterized in that the composition comprises a total content of carbonate-based filler of less than or equal to 15% by weight, relative to the total weight of said composition.

27. The moisture-crosslinkable adhesive composition as claimed in claim 17, characterized in that the composition does not comprise any carbonate-based filler.

28. The moisture-crosslinkable adhesive composition as claimed in claim 17, characterized in that the composition is a pressure-sensitive adhesive (PSA) composition.

29. The moisture-crosslinkable adhesive composition as claimed in claim 17, characterized in that the composition has, after crosslinking, an adhesive power at 180° (peel at 180°) at 23° C. of greater than or equal to 0.4 N/cm, determined according to FINAT method No. 1 of 2001.

30. The moisture-crosslinkable adhesive composition as claimed in claim 17, characterized in that the composition is in the form of a multicomponent composition comprising:
a composition U (as first component) comprising:
the silyl polymer(s) (A); and
the tackifying resin(s) (B);
optionally the compound(s) (C); and
a composition V (as second component) comprising:
the compound(s) (C);
the optional catalyst (D) being contained in composition V or alternatively in a composition W (third component).

31. A self-adhesive article comprising a support layer coated with a self-adhesive layer, characterized in that said self-adhesive layer consists of the adhesive composition as defined in claim 17 in the crosslinked state.

32. A method for improving resistance to aging of an adhesive composition after crosslinking, the method comprising adding a compound (C) as defined in claim 17 to the adhesive composition, which comprises:
a silyl polymer (A); and
a tackifying resin (B).
